(19) United States
(12) Patent Application Publication
(10) Pub. No.: US 2014/0057472 A1
(43) Pub. Date: Feb. 27, 2014

(54) CABLE CONNECTOR AND CONNECTION SYSTEM

(71) Applicant: Changzhou Amphenol Fuyang Communication Equipment Co., Ltd., (US)

(72) Inventors: Yiming XU, Changzhou (CN); Tingxing SHENG, Changzhou (CN)

(73) Assignee: Changzhou Amphenol Fuyang Communication Equipment Co., Ltd., Jiangsu (CN)

(21) Appl. No.: 13/751,526

(22) Filed: Jan. 28, 2013

(30) Foreign Application Priority Data
Aug. 27, 2012 (CN) 201220426344.5

(51) Int. Cl. H01R 13/52

(52) U.S. Cl. CPC H01R 13/5205
USPC 439/275

(57) ABSTRACT

A cable connection system that comprises a cable connector including a main housing that has first and second ends, a threaded sleeve coupled to the first end of the main housing, and a protective housing covering the main housing and coupled to the second end of the main housing. The protective housing has an open end covering the threaded sleeve. A front housing that has an open end and at least a portion of the open end of the front housing covers the open end of the protective housing, thereby forming a seal therebetween. A mating connector is configured to couple to the front housing of the cable connector.

### RELATED APPLICATION

The present application claims priority under 35 U.S.C. §119 to Chinese Patent Application No. 201220426344.5; filed Aug. 27, 2012, the entire disclosure of which is incorporated by reference therein. This application may relate to currently pending, commonly owed U.S. application Ser. No. ______, entitled Cable Connector, filed concurrently herewith.

### FIELD OF THE INVENTION

The present invention relates to the technical field of cable connectors, and more particularly to a waterproof cable connection system.

### BACKGROUND OF THE INVENTION

In mobile communication base stations or indoor coverage systems, connectors are indispensable for the transmission of high-frequency signal and power. Conventional cable connectors are mainly classified in two types: one that is equipped with annular corrugated cable; and two that is equipped with helically corrugated cable. In applications, such as outdoor antenna feed systems for mobile communication base stations, the primary method for protecting connectors from corrosion, such as from the aqueous solution of acidic and alkaline substances, is to use a daub adhesive tape to wrap the connectors. However, that method is ineffective in protecting connectors, thus leading to frequent water seepage in the connectors during use and thereby causing damage to associated equipment.

Therefore, there remains a need for a cable connector and connection system that protects against environmental damage, such as from water and corrosion.

### SUMMARY OF THE INVENTION

Accordingly, the present invention provides a cable connector that comprises a main housing that has first and second ends, a threaded sleeve that is coupled to the first end of the main housing, and a protective housing that covers that main housing and is coupled to the second end of the main housing. The protective housing has an open end that covers the threaded sleeve. A front housing that has an open end and at least a portion of the open end of the front housing covering the open end of the protective housing, thereby forming a seal therebetween.

The present invention also provides a cable connection system that comprises a cable connector including a main housing that has first and second ends, a threaded sleeve coupled to the first end of the main housing, and a protective housing covering the main housing and coupled to the second end of the main housing. The protective housing has an open end covering the threaded sleeve. A front housing that has an open end and at least a portion of the open end of the front housing covers the open end of the protective housing, thereby forming a seal therebetween. A mating connector is configured to couple to the front housing of the cable connector.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view of a cable connector according to an exemplary embodiment of the present invention;

FIG. 2 is an elevational view of a protective housing of the cable connector illustrated in FIG. 1, showing the protective housing in partial cross-section;

FIG. 3 is a cross-sectional view of a front housing of the cable connector in accordance with an exemplary embodiment of the present invention;

FIG. 4 is a cross-sectional view of a connection system in accordance with an exemplary embodiment of the present invention;

FIG. 5 is a cross-sectional view of a connection system in accordance with another exemplary embodiment of the present invention; and

FIG. 6 is an exploded view of detail A of FIG. 5, showing the coupling of a front housing and the protective housing illustrated in FIG. 5.

### DETAILED DESCRIPTION OF THE EXEMPLARY EMBODIMENTS

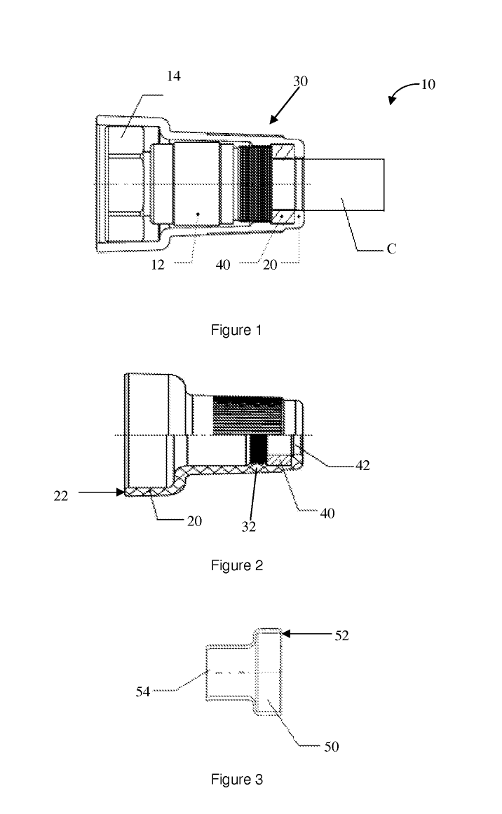

Referring to FIGS. 1-6, the present invention provides a cable connector and connection system, which includes a protective housing for water proofing the system. The cable connector 10 according to the exemplary embodiments of the present invention solves the problem of protecting connectors, such as in outdoor antenna and feeder systems where protection from corrosion and other environmental conditions is needed.

FIGS. 1 and 2 illustrate a cable connector 10 according to an exemplary embodiment of the present invention that generally comprises a main housing 12, a threaded sleeve 14 coupled to one end of the main housing 12, and a protective housing 20 coupled to the other end the main housing. The protective housing 20 covers the main housing 12 and is preferably structured in a shape of horn with an open end 22 facing towards the threaded sleeve 14. The protective housing 20 is preferably larger than the threaded sleeve 14. An outer thread 30 may be arranged on the tail part of the main housing 12 for engaging the protective housing 20. The protective housing 20 may be provided with an inner thread 32 that engages the outer thread 30 and may be arranged on the inner wall at the tail part of the protective housing 20. A rubber sealing ring 40 may be embedded in the end of the protective housing 20. The main housing 12 may be metal. The protective housing 20 may be plastic and may be formed by injection molding.

For assembly of the connector 10, one end of a cable C is extended through a connection opening 42 on the protective housing 20 to install the cable C in the connector 10. The protective housing 20 is then threaded onto the main housing 12, such that the sealing ring 40 is axially deformed to wrap around the cable C so that water is prevented from entering the tail part of the connector 10 along the cable C.

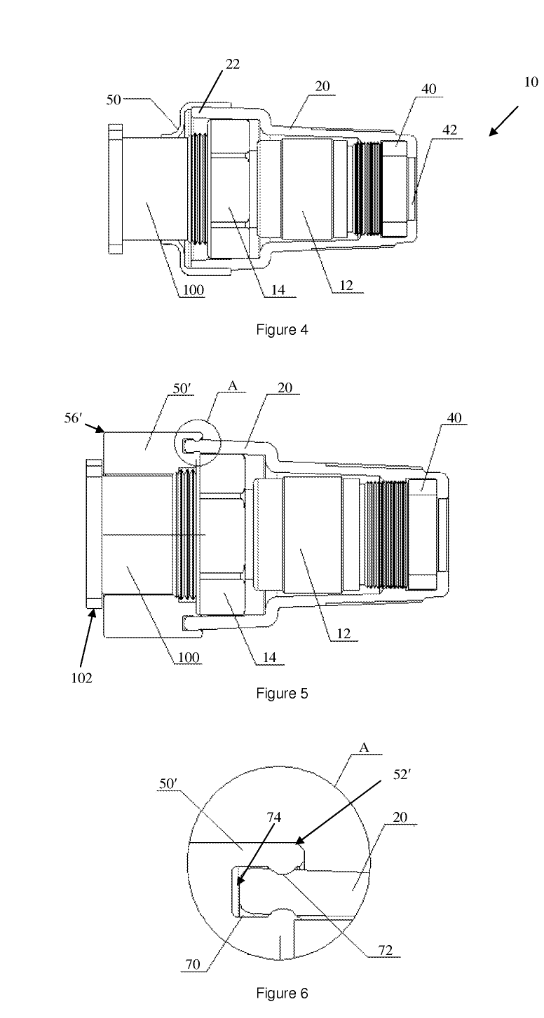

As seen in FIGS. 3 and 4, a front housing 50 may be provided that engages the protective housing 20 in a sealing manner. The open end 52 of the front housing 50 is preferably sleeved on the open end 22 of the protective housing 20 and the front housing 50 is radially deformed to achieve a sealing connection therebetween. The protective housing 20 may be structured in a shape of a horn. To improve the waterproof property of the connector 10, the inner diameter at the open end 52 of the front housing 50 may be smaller than the outer diameter at the open end 22 of the protective housing 20 such that when mated, a tight seal is formed therebetween with the open end 52 of the housing 50 covering the open end 22 of the protective housing. To further improve the waterproof property of the connector 10, an inner bore 54 opposite the open end 52 on the front housing 50 is preferably in tight sealing connection with the mating connector 100 (FIG. 5). The front housing 50 and the protective housing 20 may be made of plastic or rubber.

FIGS. 5 and 6 illustrate another exemplary embodiment according to the present invention that includes a modified front housing 50′ of the connector 10. A ring-shaped groove 70 may be formed on the face of the opening end 52′ of the front housing 50′. Protrusions 72 are defined by the groove 70 and formed on the upper and lower faces of the groove 70 for engaging the open end 22 of the protective housing 20, as seen in FIGS. 5 and 6. When front housing 50′ engages the protective housing 20, the open end 22 of the protective housing 20 is received in the ring-shaped groove 70 at the open end 52′ of the front housing 50′ and is in tight connection with the protrusions 72 in the groove 70. To further improve the waterproof property of the connector 10, a tail end 56′ of the front housing 50′ may come into contact with a flange face 102 of the mating connector 100, as best seen in FIG. 5.

The connector 10 according to this exemplary embodiment of the present invention is designed such that the head part of the open end 22 of the protective housing 20 is inserted into the groove 70 of the front housing 50′, and the face of the open end 22 abuts against the end face 74 of the groove 70 of the front housing 50′ so that axial deformation is generated. The two protrusions 72 in the groove 70 come into contact with the inner and outer diameters of the head part of the open end 22 of the protective housing 20 respectively, thus generating an elastic deformation to provide a waterproof seal.

While particular embodiments have been chosen to illustrate the invention, it will be understood by those skilled in the art that various changes and modifications can be made therein without departing from the scope of the invention as defined in the appended claims.

What is claimed is:

1. A cable connector, comprising:
a main housing having first and second ends;
a threaded sleeve coupled to said first end of said main housing;
a protective housing covering said main housing and coupled to said second end of said main housing, said protective housing having an open end covering said threaded sleeve; and
a front housing having an open end, at least a portion of said open end of said front housing covering said open end of said protective housing, thereby forming a seal therebetween.

2. A cable connector according to claim 1, further comprising
a sealing ring disposed between said protective housing and said main housing.

3. A cable connector according to claim 1, wherein
said protective housing is threadably coupled to said second end of said main housing.

4. A cable connector according to claim 1, wherein
said front housing includes a ring-shaped groove formed on a face of said open end of said front housing defining protrusions on said open end of said front housing, said groove receiving said protective housing such that said protrusions cover said open end of said protective housing.

5. A cable connector according to claim 1, wherein
prior to coupling said front housing and said protection housing, an inner diameter of said open end of said front housing is smaller than an outer diameter of said open end of said protection housing.

6. A cable connector according to claim 1, wherein
said protection housing is structured in the shape of a horn.

7. A cable connector according to claim 1, wherein
said front housing is formed of rubber.

8. A cable connection system, comprising:
a cable connector including a main housing having first and second ends, a threaded sleeve coupled to said first end of said main housing, a protective housing covering said main housing and coupled to said second end of said main housing, said protective housing having an open end covering said threaded sleeve, and a front housing having an open end, at least a portion of said open end of said front housing covering said open end of said protective housing, thereby forming a seal therebetween; and
a mating connector configured to couple to said front housing of said cable connector.

9. A cable connection system according to claim 8, wherein
said front housing having an inner bore that receives a portion of said mating connector in a tight sealing connection.

10. A cable connection system according to claim 9, wherein
said front housing having a tail end that abuts a flange face of said mating connector.

11. A cable connection system according to claim 8, wherein
a sealing ring disposed between said protective housing and said main housing.

12. A cable connection system according to claim 8, wherein
said protective housing is threadably coupled to said second end of said main housing.

13. A cable connection system according to claim 8, wherein
said front housing includes a ring-shaped groove formed on a face of said open end of said front housing defining protrusions on said open end of said front housing, said groove receiving said protective housing such that said protrusions cover said open end of said protective housing.

14. A cable connection system according to claim 8, wherein
prior to coupling said front housing and said protection housing, an inner diameter of said open end of said front housing is smaller than an outer diameter of said open end of said protection housing.

15. A cable connection system according to claim 8, wherein
said protection housing is structured in the shape of a horn.

16. A cable connection system according to claim 8, wherein
said front housing is formed of rubber.
